(19) United States
(12) Patent Application Publication
(10) Pub. No.: US 2011/0193682 A1
(43) Pub. Date: Aug. 11, 2011

(54) REMOTE FIRE DETECTION BYPASS FOR TESTING FIRE-SMOKE ALARM AND INDICATION DEVICES

(76) Inventor: Salvador SeBasco, Escondido, CA (US)

(21) Appl. No.: 12/962,542

(22) Filed: Dec. 7, 2010

Related U.S. Application Data
(60) Provisional application No. 61/267,391, filed on Dec. 7, 2009.

(51) Int. Cl. G08B 17/02

(52) U.S. Cl. 340/6.1

(57) ABSTRACT

The importance of fire safety equipment and systems is great as they protect buildings and the people within those buildings from the danger of fire. Regular testing of these systems is highly important to ensure their ability to provide such protection. However, current fire safety equipment, especially fire and smoke alarms require manual activation to be tested and are located out of reach for such testing to be done easily and conveniently. The present device provides a means to test fire safety equipment and systems without the need to reach the device manually, rather this device allows fire safety equipment and systems to be tested through the use of a remote switch which can be conveniently located and easily reached.

### CROSS-REFERENCE TO RELATED APPLICATIONS

This application claims the benefit of priority to prior-filed U.S. Provisional patent application Ser. No. 61/267,391, filed Dec. 7, 2009, the complete contents of which is hereby incorporated herein by reference.

### BACKGROUND

1. Field of the Invention

The present disclosure relates generally to the field of fire safety and fire warning devices and more specifically to a remote fire equipment testing system to test emergency fire equipment and systems through the use of a hand-held device.

2. Background

To ensure the safety of residential, commercial and industrial buildings and their occupants in the event of a fire, all buildings must be equipped with fire safety equipment and systems. Fire alarm and indication devices and systems are complex and require many parts to work properly in unison to successfully warn of the serious danger a fire presents. For fire safety equipment and systems to be maintained in a condition so as to be reliable in the event of a fire they must be regularly tested to ensure their ability to perform as designed in the event of a fire.

Fire safety equipment and systems include various smoke detectors and alarms, fire alarm systems, emergency exit signs, various automatic emergency lighting, etc. The manufacturers of such equipment and systems strongly recommend these devices and systems be tested weekly or monthly. Furthermore, fire safety equipment and systems in commercial and industrial buildings are required by law to be tested on a weekly or monthly basis depending on the specific equipment and system.

Such testing is often cumbersome because fire safety equipment and systems are often located in inconvenient and out-of-reach places (usually on ceilings or at the top of walls) and require a button be pressed on the device in order to conduct a test of the device performance. The often arduous effort required in reaching fire/smoke alarms and indication equipment to test their performance prevents many fire/smoke alarms and fire safety systems from being properly tested. Especially in residential homes where one or two adults may be responsible for testing multiple alarms on a monthly basis which all require a ladder to access, such testing can easily be ignored and forgotten as requiring too much time and effort.

The current method of fire safety equipment and system testing, which most often requires a button be pressed on a device located on a ceiling or at the top of a wall, leads such equipment to not be tested as often as is proper. Buildings equipped with fire safety equipment and systems that are not tested as often as recommended by the manufacturer present a danger to people located within such buildings that the building may catch on fire and those within the building will not be warned of the fire in time to exit the building safely.

What is needed is a device that can initiate the test for fire safety equipment from a location remote from that of the fire safety equipment itself. It is desired that the device bypass the fire/smoke detection circuitry and test the fire alarm/indication function of the fire safety equipment.

### BRIEF DESCRIPTION OF THE DRAWINGS

FIG. 1 depicts a schematic of an embodiment of the present device (test switch/bypass circuitry) wired to bypass a smoke detection circuit to activate a test of the fire indication/alarm circuitry.

FIG. 2 depicts an embodiment of the transmitter that comprises a battery indicator light, a light and/or speaker to indicate signal transmission, and a button that when pressed sends a signal to the receiver that will test the fire indication/alarm circuitry.

FIG. 3 depicts a flow chart depicting the operation of the system depicted in FIGS. 1 and 2.

### DETAILED DESCRIPTION

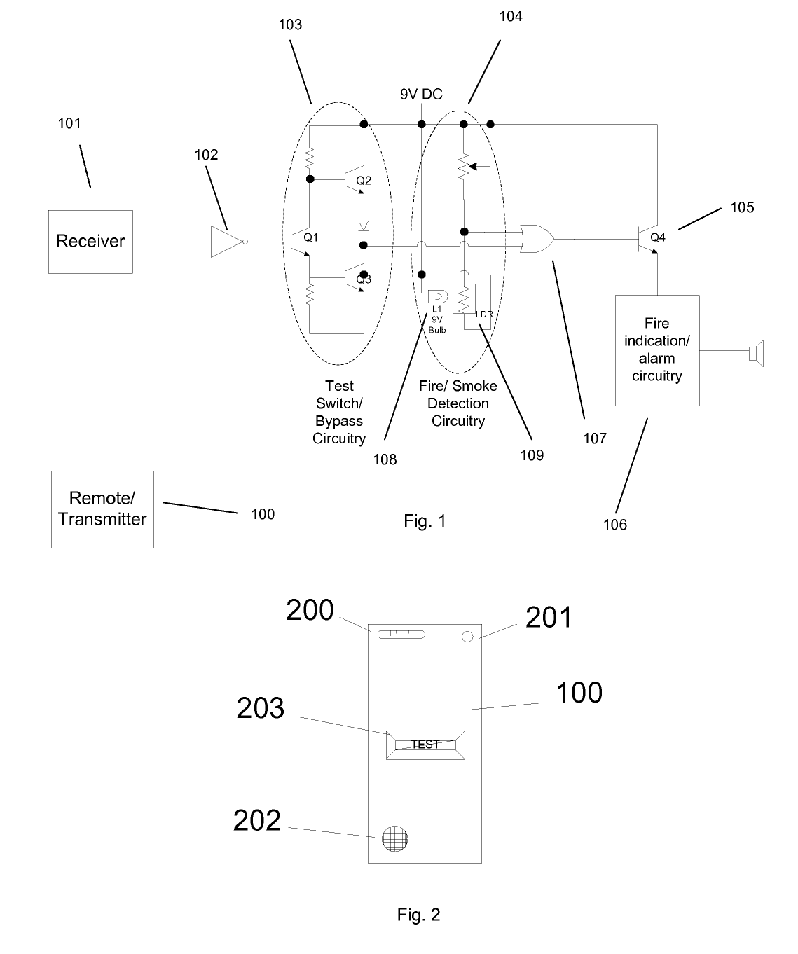

FIG. 1 depicts an embodiment of the present device wired as a bypass to the detection circuitry 104 of a smoke detector. The present device can be wired as a bypass to the detection circuitry to any fire safety equipment to allow the fire indication/alarm circuitry of such equipment to be tested without requiring the fire safety device be manually activated and without the detection of an actual fire or smoke to trigger the indication/alarm circuitry.

The device is comprised of two parts: one part can be a remote transmitter 100 which can be located in a conveniently accessible place to the user and the second part is comprised of a receiver 101 and bypass circuitry 102 and 103 which can be connected directly to the fire safety device. To test the fire safety equipment 106 the user can press a button 203 on the remote transmitter 100 which can send a signal to the receiver 101. In some embodiments, the signal sent from the remote transmitter 100 to the receiver 101 can be wireless, but in other embodiments can be sent via an electrical, optical, or any other known and/or convenient conduit. If a wireless embodiment is employed, the power of the signal sent from the remote transmitter 100 can be such that the range for successful transmission can require the transmitter be within approximately 10 m of the receiver 101 when the button is pressed in order to prevent inadvertent activations of the fire indication/alarm circuitry and/or to allow the device to consume minimal power.

In some embodiments the remote transmitter 100 can contain a battery indicator light 200 or other convenient indicator of the transmitter's battery power to signify to the user that that battery power of the transmitter is sufficient to send the desired signal to the receiver. The transmitter can also contain one or a plurality of indicator light(s) 201 and/or a speaker 202 to indicate either by light or by sound that the transmitter successfully sent the signal and/or if the receiver 101 received that signal.

In some embodiments when the button 203 on the transmitter 100 is pressed and the transmitter 100 is within the prescribed distance from the receiver 101, the receiver 101 can detect the signal from the transmitter 100 and can output a high signal which can be made low by the inverter 102. That low signal input to the switch 103 can output a high signal to the ‘or’ gate 107 which can put a high signal on the base of junction 105, switching junction 105 from cutoff to saturation, allowing current to flow to the fire alarm circuitry, as if a fire had been detected; thus testing the fire indication/alarm circuitry 106.

In some embodiments, when the signal received by the receiver 101 is other than above a prescribed value, the receiver 101 can output a low signal which can be made high by the inverter 102. The high signal input to the switch 103 can output a low signal to the ‘or’ gate 107. If the fire/smoke detection circuitry 104 detects fire or smoke (for example, in FIG. 1 the light emitted by indicator 108 is blocked before reaching the variable resistor 109, causing the variable resistor 109 to increase resistance) a high signal can be sent to the ‘or’ gate 107 which can put a high signal on the base of junction 105, switching junction 105 from cutoff to saturation, allowing current to flow to the fire alarm circuitry 106.

If neither the test switch/bypass circuitry 103 nor the fire/smoke detection circuitry 104 are activated they will both send low signals to the ‘or’ gate 107 which can output a low signal to junction 105, keeping junction 105 in a cutoff state and preventing current from flowing to the fire indication/alarm circuitry 106. Thus, the fire indication/alarm circuitry 106 will remain ‘off’ until fire/smoke is detected unless the button 203 on the transmitter 100 is pressed and a signal is successfully sent from the transmitter 100 and received by the receiver 101.

The circuitry configuration in FIG. 1 as well as the test switch/bypass circuitry 103 provided in FIG. 1 and referred to above can be accomplished through numerous alternative means through various electrical systems and can provide a function equal to that of the circuitry shown in FIG. 1.

The circuitry of the fire/smoke detection circuitry 104 in FIG. 1 can vary with different fire safety equipment and systems. Test switch/bypass circuitry 103 can be adapted to successfully bypass various fire safety equipment and systems to allow a remote transmitter 100 to activate and test the fire indication/alarm circuitry.

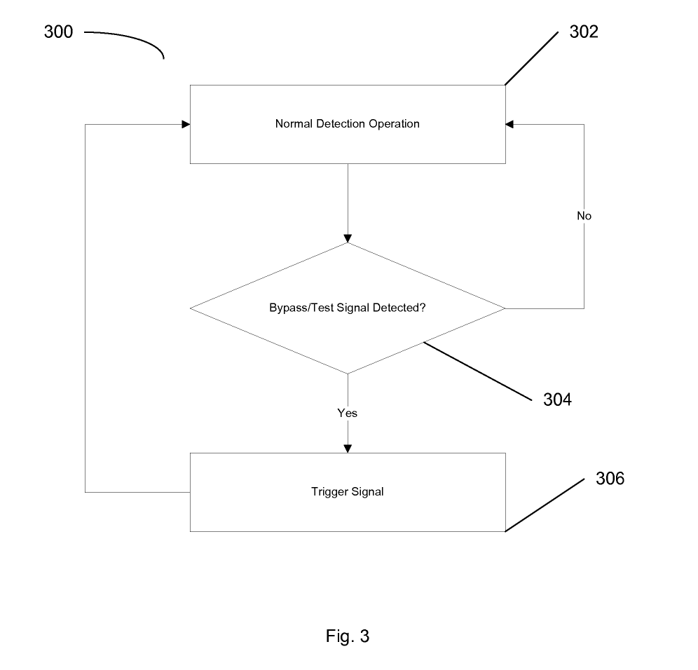

FIG. 3 depicts a flow chart depicting the operation of the system depicted in FIGS. 1 and 2. In the embodiment depicted in FIG. 3, the system 300 can operate in a normal detection mode 302. In the normal detection mode, the detection system can perform the normal functions of detecting an event, such as excess smoke for a smoke detector or excess carbon monoxide for a carbon monoxide detector and/or any other known and/or convenient detection function. In step 302, the system 300 can test for and/or detect a bypass/test signal, such as can be transmitted by the device depicted in FIG. 2. If the system 300 detects a bypass/test signal, an alarm can be triggered. In some embodiments the alarm can be visual and/or audible. However, in alternate embodiments any known and/or convenient alarm signal can be emitted by the system in response to the bypass/test signal. If the system 300 does not detect a bypass/test signal, the system 300 can return to a normal operation state 302. In some embodiments the cycle of the detection to normal state can be less than 1 ms. However, in alternate embodiments the cycle of the system 300 can have any known and/or convenient duration. In still further alternate embodiments a cycle frequency/period may not be present.

Although the invention has been described in conjunction with specific embodiments thereof, it is evident that many alternatives, modifications and variations will be apparent to those skilled in the art. Accordingly, the invention as described and hereinafter claimed is intended to embrace all such alternatives, modifications and variations that fall within the spirit and broad scope of the appended claims.

What is claimed is:

1. A remote fire safety equipment testing system, comprising:
bypass circuitry able to connect to bypass fire/smoke detection circuitry and able to activate fire/smoke alarm and indication circuitry, and a signal communication system;
wherein said signal communication system further comprises a receiver connected to said bypass circuitry, and a remote transmitter;
wherein said remote transmitter contains a push-button to activate said fire/smoke alarm and indication circuitry.

2. The remote fire safety equipment testing system of claim 1, wherein said fire/smoke detection circuitry consists of automatic emergency lighting.

3. The remote fire safety equipment testing system of claim 1, wherein said fire/smoke detection circuitry consists of smoke detectors.

4. The remote fire safety equipment testing system of claim 1, wherein said the fire/smoke detection circuitry consists of a plurality of emergency fire indication devices.

5. The remote fire safety equipment testing system of claim 4, wherein said transmitter contains a plurality of manual switches capable of selecting various said emergency fire indication devices to activate.
